(19) United States
(12) Patent Application Publication
(10) Pub. No.: US 2015/0358718 A1
(43) Pub. Date: Dec. 10, 2015

(54) HEADPHONE RESPONSIVE TO OPTICAL SIGNALING

(71) Applicant: Cirrus Logic, Inc., Austin, TX (US)

(72) Inventors: Roy Scott Kaller, Austin, TX (US); Aaron Brennan, Austin, TX (US)

(21) Appl. No.: 14/299,836

(22) Filed: Jun. 9, 2014

(51) Int. Cl. H04R 1/10

(52) U.S. Cl. CPC H04R 1/1091

(57) ABSTRACT

An optical sensor may be integrated into headphones and feedback from the sensor used to adjust an audio output from the headphones. For example, an emergency vehicle traffic preemption signal may be detected by the optical sensor. Optical signals may be processed in a pattern discriminator, which may be integrated with an audio controller integrated circuit (IC). When the signal is detected, the playback of music through the headphones may be muted and/or a noise cancellation function turned off. The optical sensor may be integrated in a music player, a smart phone, a tablet, a cord-mounted module, or the earpieces of the headphones.

### FIELD OF THE DISCLOSURE

The instant disclosure relates to mobile devices. More specifically, this disclosure relates to audio output of mobile devices.

### BACKGROUND

Mobile devices, such as smart phones, are carried by a user throughout most or all of a day. These devices include the capability of playing music, videos, or other audio through headphones. Users often take advantage of having a source of music available throughout the day. For example, users often walk along the streets, ride bicycles, or ride motorized vehicles with headphones around their ears or headphone earbuds inserted in their ears. The use of the headphones impairs the user's ability to receive audible clues about the environment around them. For example, a user may be unable to hear the siren of an emergency vehicle while wearing the headphones with audio playing from the mobile device.

In addition to the physical impairment to audible sounds created by a user wearing the headphones, the mobile device and/or the headphones may implement noise cancellation. With noise cancellation, a microphone near the mobile device or headphones is used to detect sounds in the surrounding environment and intentionally subtract the sounds from what the user hears. Thus, when noise cancellation is active, the user only hears the audio from the device. For example, the mobile device or headphones may generate a signal that is out-of-phase with the sounds and add the out-of-phase signal to the music played through the headphones. Thus, when the environmental sound reaches the user's ear, the cancellation signal added to the music offsets the environmental sound and the user does not hear the environment. When the audible sound is the siren of an emergency vehicle, the user may be unaware of an emergency around him or may be unaware of an approaching high speed vehicle. This has become a particularly dangerous situation as noise cancellation in headphones has improved.

One conventional solution is for the mobile device to detect certain sounds, such as an emergency siren through the microphone and mute the audio output through the headphones while particular sounds are detected. However, this solution requires advance knowledge of each of the sounds. For example, a database of all emergency sirens would need to be created and updated regularly in order to recognize all emergency vehicles. Furthermore, the input from the microphone is noisy and the emergency siren may be covered by other nearby audible sounds, such as nearby car engines, generators, wildlife, etc. Thus, audibly detecting warning sounds may be difficult, and mute functionality based on audible detection of sounds may not be reliable.

Shortcomings mentioned here are only representative and are included simply to highlight that a need exists for improved audio devices and headphones, particularly for consumer-level devices. Embodiments described here address certain shortcomings but not necessarily each and every one described here or known in the art.

### SUMMARY

Optical detection of particular signals identifying activity in a user's environment may be used to alert the user to certain activities. For example, emergency vehicles often include systems that generate optical signals, such as strobe lights. These optical signals may be detected and their presence used to take action by adjusting audio output of the headphones. These headphones may be paired with smart phones, tablets, media players, and other electronic devices. Sensors may be added to the headphones or to a device coupled to the headphones to detect optical signaling and take action in response to the detected optical signaling.

According to one embodiment, an apparatus may include an optical sensor and an audio controller coupled to the optical sensor. The audio controller may be configured to output an audio signal to an audio transducing device; detect an optical pattern corresponding to a presence of a vehicle in a signal received through the optical sensor; and/or adjust the output audio signal based, at least in part, on the detection of the optical pattern corresponding to the presence of the vehicle.

In some embodiments, the apparatus may also include a microphone coupled to the audio controller, and the microphone may receive an audio signal from the environment around the audio transducing device.

In certain embodiments, the audio controller may be configured to adjust the output audio signal by muting the output audio signal after the optical pattern is detected, turning off a noise cancellation signal within the audio signal after the optical pattern is detected, and/or adding to the output audio signal an audio signal corresponding to an audio signal representative of an environment around the audio transducing device after the optical pattern is detected; the optical sensor may be a visible light sensor or an infrared (IR) sensor; the audio controller may also be configured to generate an anti-noise signal for canceling audio, received through the microphone, in the environment around the audio transducing device using at least one adaptive filter, add to the output audio signal the anti-noise signal, and adjust the output audio signal by disabling the adding of the anti-noise signal to the output audio signal after the optical pattern is detected; the audio controller may also be configured to disable the detection of the optical pattern; the detected optical signal may correspond to a strobe of a traffic control preemption signal of an emergency vehicle; the optical sensor may be attached to a cord-mounted module attached to the apparatus; and/or the optical sensor may be attached to the audio transducing device.

According to another embodiment, a method may include receiving, at an audio controller, a first input corresponding to a signal received from an optical sensor; receiving, at the audio controller, a second input corresponding to an audio signal for playback through an audio transducing device; detecting, by the audio controller, a pattern indicating a presence of a vehicle in the first input; and/or adjusting, by the audio controller, the audio signal for playback through the audio transducing device after the pattern is detected.

In some embodiments, the method may also include receiving, at an audio controller, a third input corresponding to an audio signal received from a microphone in an environment around the audio transducing device; generating, by the audio controller, an anti-noise signal for canceling audio in the environment around the audio transducing device using at least one adaptive filter; detecting, by the audio controller, a vehicle strobe pattern in the first input; and/or disabling the detection of the pattern.

In certain embodiments, the step of adjusting the audio signal may include muting the output audio signal when the pattern is detected, turning off a noise cancellation signal within the audio signal when the pattern is detected, and/or adding to the output audio signal an audio signal corresponding to an audio signal representative of an environment around the audio transducing device when the pattern is detected; and/or the pattern may correspond to a strobe of a traffic control preemption signal of an emergency vehicle.

According to a further embodiment, an apparatus may include an optical sensor; an audio input node configured to receive an audio signal; an audio transducing device coupled to the audio input node; and/or a pattern discriminator coupled to the optical sensor and coupled to the audio transducing device. The pattern discriminator may be configured to detect a pattern indicating a presence of a vehicle at the optical sensor and/or mute the audio transducing device when the pattern is detected.

In some embodiments, the method may also include a controller configured to adjust an output audio signal of the audio transducing device based, at least in part, on the detection of the pattern.

In certain embodiments, the detected pattern may include a strobe of a traffic control preemption signal of an emergency vehicle; the optical sensor may include a visible light sensor or an infrared (IR) sensor; the optical sensor, the audio transducing device, and the pattern discriminator may be integrated into headphones; and/or the audio controller may be configured to adjust the output audio signal by turning off a noise cancellation signal within the audio signal after the pattern is detected or adding to the output audio signal an audio signal corresponding to an audio signal representative of an environment around the audio transducing device after the pattern is detected.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a drawing illustrating an audio system with an optical sensor embedded in the headphones, a cord-mounted module, and/or an electronic device according to one embodiment of the disclosure.

FIG. 2 is a drawing illustrating an emergency vehicle pattern as one optical signal that an optical sensor may detect according to one embodiment of the disclosure.

FIG. 3 is a block diagram illustrating an audio controller and optical sensor for controlling an output of a speaker according to one embodiment of the disclosure.

FIG. 4 is a flow chart illustrating a method of controlling headphones based on a pattern detected from an optical signal according to one embodiment of the disclosure.

FIG. 5 is a block diagram illustrating an audio controller for mixing several signals for output to headphones based on a pattern detected from an optical signal according to one embodiment of the disclosure.

FIG. 6 is a flow chart illustrating a method of adjusting audio output with an anti-noise signal according to one embodiment of the disclosure.

### DETAILED DESCRIPTION

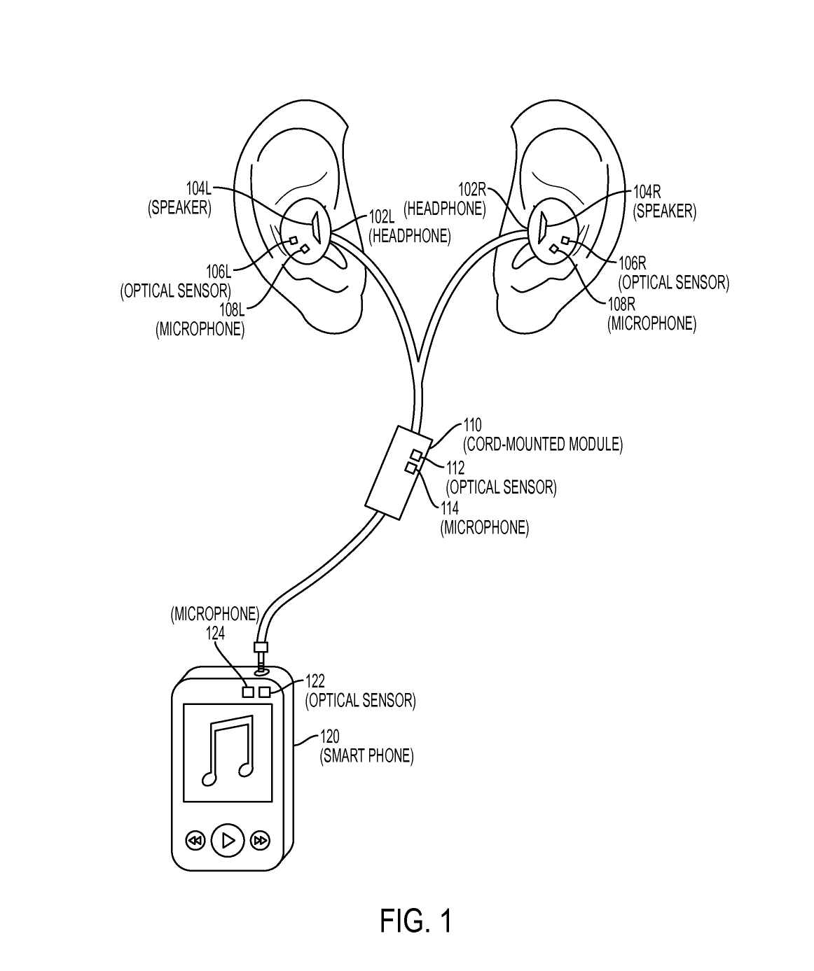

FIG. 1 is a drawing illustrating an audio system with an optical sensor embedded in the headphones, a cord-mounted module, and/or an electronic device according to one embodiment of the disclosure. Headphones 102L and 102R may be coupled to an electronic device 120, such as an MP3 player, a smart phone, or a tablet computer. The headphones 102L and 102R may include speakers 104L and 104R, respectively. The speakers 104R and 104L transduce an audio signal provided by the electronic device 120 into sound waves that a user can hear. The headphones 102L and 102R may also include optical sensors 106L and 106R, respectively. The optical sensors 106L and 106R may be, for example, infrared (IR) sensors or visible light sensors. The headphones 102L and 102R may further include microphones 108L and 108R, respectively.

Optical sensors may be included on components other than the headphones 102L and 102R. A cord-mounted module 110 may be attached to a wire for the headphones 102L and 102R and may include an optical sensor 112. The electronic device 120 coupled to the headphones 102L and 102R may also include an optical sensor 122. Although optical sensors 106L, 106R, 112, and 122 are illustrated, not all the optical sensors may be present. For example, in one embodiment the optical sensor 112 is the only optical sensor. In another embodiment, the optical sensor 122 is the only optical sensor.

Microphones may be included in the audio system for detecting environmental sounds. The microphone may be located on components other than the headphones 102L and 102R. The cord-mounted module 110 may also include a microphone 114, and the electronic device 120 may also include a microphone 124. Although microphones 108L, 108R, 114, and 124 are illustrated, not all the microphones may be present. For example, in one embodiment, the microphone 124 is the only microphone. In another embodiment, the microphone 114 is the only microphone.

Output from optical sensors 106L, 106R, 112, and 122 and microphones 108L, 108R, 114, and 124 may be provided to an audio controller (not shown) located in the headphones 104L, 104R, in the cord-mounted module 110, or in the electronic device 120. In one embodiment, the audio controller may be part of the electronic device 120 and constructed as an integrated circuit (IC) for the electronic device 120. The IC may include other components such as a generic central processing unit (CPU), digital signal processor (DSP), audio amplification circuitry, digital to analog converters (DACs), analog to digital converters (ADC), and/or an audio coder/decoder (CODEC).

The audio controller may process signals including an internal audio signal containing music, sound effects, and/or audio, an external audio signal, such as from a microphone signal, a down-stream audio signal for a telephone call, or a down-stream audio signal for streamed music, and/or a generated audio signal, such as an anti-noise signal. The audio controller may generate or control generation of an audio signal for output to the headphones 102L and 102R. The headphones 102L and 102R then transduce the generated audio signal into audible sound recognized by the user's ears. The audio controller may utilize signals from the optical sensors 106L, 106R, 112, and 122 to recognize specific patterns and take an action based on the detection of a specific pattern. For example, the audio controller may select input signals used to generate the audio signal based, at least in part, on the detection of a specific pattern in the signal from the optical sensors 106L, 106R, 112, and/or 122.

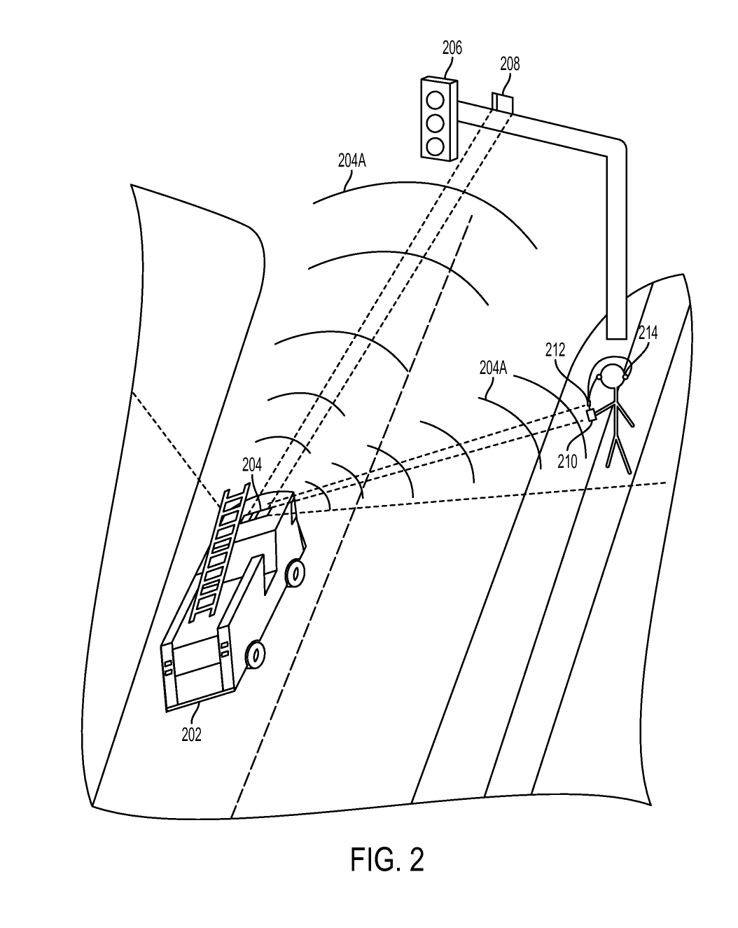

In one example, the specific pattern may be a signal corresponding to the presence of a vehicle, such as an emergency vehicle strobe signal. The optical sensors 106L, 106R, 112, and 122 may be configured to receive the optical signal, and the audio controller may be configured to discriminate and identify the optical signal. In one embodiment, the pattern discriminator is configured to recognize a strobe signal corresponding to an emergency vehicle traffic preemption signal. FIG. 2 is a drawing illustrating an emergency vehicle strobe as one optical signal that an optical sensor may detect according to one embodiment of the disclosure. An emergency vehicle 202, such as a fire truck or an ambulance, may generate strobe signals 204A from light elements 204. The strobe signal 204A activates a strobe signal detector 208 mounted with traffic light 206. The strobe signal detector 208 may cycle the traffic light 206 upon detection of the strobe signal 204A to allow the emergency vehicle 202 to pass through the intersection unimpeded.

A user may be walking alongside the road using smart phone 210 and headphones 214. With music playing through the headphones 214, the user may be unable to hear the approach of the emergency vehicle 202. An optical sensor 212 in the smart phone 210 may detect strobe signal 204A. When the smart phone 210 detects the strobe signal 204A, the smart phone 210 may adjust audio output through the headphones 214. For example, the smart phone 210 may mute the audio output through the headphones 214. In another example, the smart phone 210 may disable noise cancelling within the headphones 214 to allow the user to hear the emergency siren broadcast by the emergency vehicle 202. In a further example, the smart phone 210 may pass to the headphones 214 an audio signal from a microphone that is receiving the emergency siren.

Although the optical sensor 212 is shown on the smart phone 210, the optical sensor 212 may be alternatively placed on a cord-mounted module (not shown) or the headphones 214, as described above with reference to FIG. 1. Further, although the smart phone 210 is described as performing discrimination on the signal of optical sensor 212 and adjusting the audio output to the headphones 214, the processing may be performed by an audio controller housed in the headphones 214 or a cord-mounted module.

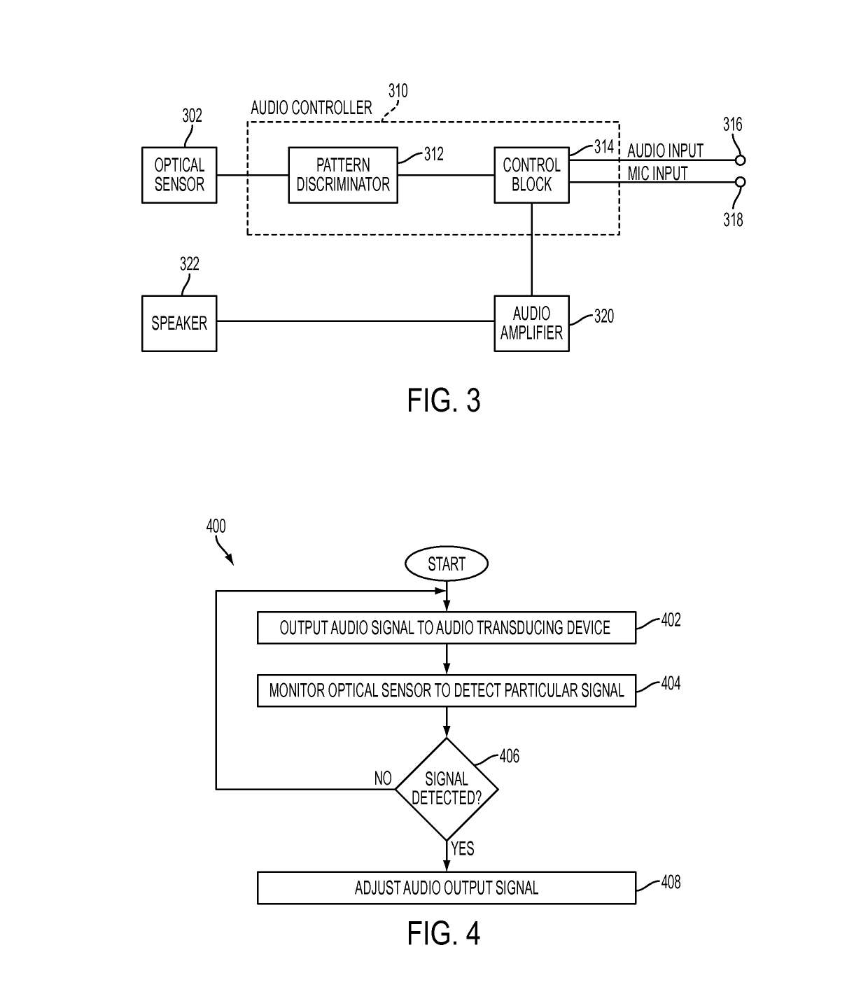

An audio controller, regardless of where it is located, may be configured to include several blocks or circuits for performing certain functions. FIG. 3 is a block diagram illustrating an audio controller and optical sensor for controlling an output of a speaker according to one embodiment of the disclosure. An audio controller 310 may include a pattern discriminator 312 and a control block 314. The pattern discriminator 312 may be coupled to an optical sensor 302 and be configured to detect certain patterns within the signals received from the optical sensor 302. For example, the pattern discriminator 312 may include a database of known patterns of emergency vehicles and attempt to match signals from the optical sensor 302 to a known pattern. The patterns may be set by standards or local authorities and may be a repeated flashing of light at a set frequency or a specific pattern of frequencies.

Signals may be identified by processing data received from the optical sensor 302 at the pattern discriminator 312 and/or the control block 314. In one example, the pattern discriminator 312 may count a number of flashes of the strobe signal within a fixed time window. In another example, a message in the received optical signal may be decoded using clock and data recovery. In a further example, the pattern discriminator 312 may perform analysis on a signal from the optical sensor 302 to determine the presence of a certain pattern. In one embodiment, the pattern discriminator 312 may perform a Fast Fourier Transform (FFT) on a signal received by optical sensor 302 and determine whether the received signal has a particular frequency component. A pattern discriminator 312 may also use FFT to detect a pattern of frequencies in the optical sensors.

When the pattern discriminator 312 receives a positive match, the pattern discriminator 312 transmits a control signal to the control block 314. The control block 314 may also receive an audio input from input node 316, which may be an internal audio signal such as music selected for playback on an electronic device. Further, the control block 314 may receive a microphone input from input node 318. The control block 314 may generate an audio signal for transmission to the audio amplifier 320 for output to the speaker 322. The control block 314 may generate the audio signal based on the match signal from the pattern discriminator 312. In one example, when a positive match signal is received, the control block 314 may adjust an audio signal output to the speaker 322. In one embodiment, when a positive match signal is received, the control block 314 may include only the microphone input in the audio signal transmitted to the speaker 322. This may allow the user to hear the emergency vehicle passing by. When a negative match signal is later received, the control block 314 may include only the audio input in the audio signal transmitted to the speaker 322, which allows the user to return to music playback.

A flow chart for operation of the control block 314 is shown in FIG. 4. FIG. 4 is a flow chart illustrating a method of controlling headphones based on a pattern detected from an optical signal according to one embodiment of the disclosure. A method 400 begins at block 402 with outputting an audio signal to an audio transducing device, such as speaker 322 of a headphone. At block 404, the optical sensor is monitored, such as through the pattern discriminator 312, to detect a particular signal. At block 406, it is determined whether the signal is detected. If no signal is detected, the method 400 returns to blocks 402 and 404. If the signal is detected at block 406, then the method 400 continues to block 408 to adjust the audio output signal, such as my muting an internal audio signal.

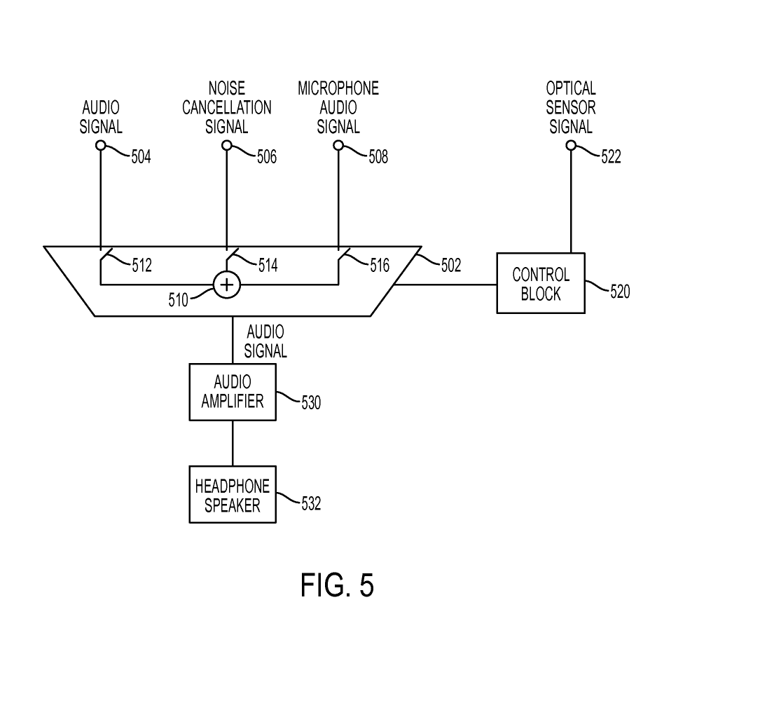

An audio controller may have several alternative actions available to adjust an audio signal when a signal is detected by the optical sensor. The action taken may be based, for example, on which particular pattern is detected within the optical sensor and/or a user preference indicated through a setting in the electronic device or a switch on the headphones. FIG. 5 is a block diagram illustrating an audio controller for mixing several signals for output to headphones based on a pattern detected from an optical signal according to one embodiment of the disclosure. A control block 520 may be coupled to an optical sensor signal through input node 522, such as through a pattern discriminator. The control block 520 may control the operation of a mux 502, which generates an audio signal for output to an audio amplifier 530 and a headphone speaker 532.

The mux 502 may include a summation block 510 with one or more input signals. The input signals may include an internal audio signal, such as music, received at an input node 504, a noise cancellation signal received at input node 506, and/or a microphone audio signal received at input node 508. The mux 502 may include switches 512, 514, and 516 to couple or decouple the input nodes 504, 506, and 508 from the summation block 510. The switches 512, 514, and 516 may be controlled by the control block 520 based, at least in part, on a match signal that may be received from the input node 522. For example, the control block 520 may mute the internal audio signal by disconnecting switch 512. In another example, the control block 520 may disable a noise cancellation signal by deactivating the switch 514. In a further example, the control block 520 may disable a noise cancellation signal by deactivating the switch 514 and pass through a microphone signal by activating the switch 516. In one embodiment, the noise cancellation signal received at input node 506 may be an adaptive noise cancellation (ANC) signal generated by an ANC circuit. Additional disclosure regarding adaptive noise cancellation (ANC) may be found in U.S. Patent Application Publication No. 2012/0207317 corresponding to U.S. patent application Ser. No. 13/310,380 filed Dec. 2, 2011 and entitled “Ear-Coupling Detection and Adjustment of Adaptive Response in Noise-Canceling in Personal Audio Devices” and may also be found in U.S. patent application Ser. No. 13/943,454 filed on Jul. 16, 2013, both of which are incorporated by reference herein.

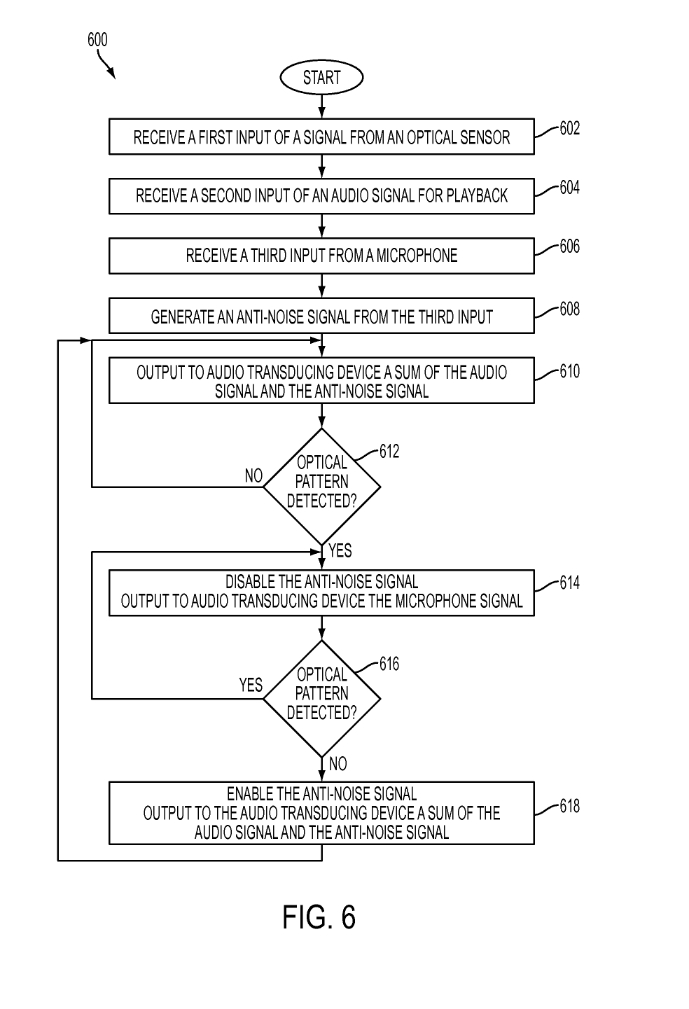

When the control block 520 is configured, whether by user preference or in response to a particular detected optical pattern, to control noise cancellation, the control block 520 may be configured to execute the method shown in FIG. 6. FIG. 6 is a flow chart illustrating a method of adjusting audio output with an anti-noise signal according to one embodiment of the disclosure. A method 600 begins at block 602 with receiving a first input of a signal from an optical sensor, at block 604 with receiving a second input of an audio signal for playback, and at block 606 with receiving a third input from a microphone. At block 608, an anti-noise signal may be generated from the third input, either by the control block 520 or by another circuit under control of the control block 520. At block 610, the control block 520 may control a multiplexer to sum the audio signal received at the second input at block 604 and the anti-noise signal received from the third input at block 608. This summed audio signal may be transmitted to an amplifier for output at headphones.

At block 612, the control block 520 determines whether an optical pattern is detected. When the optical pattern is not detected, the control block 520 returns to block 610 to continue providing audio playback. When the optical pattern is detected, the method 600 continues to block 614 where the control block 520 may disable the anti-noise signal and select the microphone signal received at block 606 for output to the audio transducing device, such as the headphones. In one embodiment shown in FIG. 5, block 614 may involve the control block 520 deactivating the switches 512 and 514 and activating the switch 516.

At block 616, it is determined whether the optical pattern is still detected. As long as the optical pattern is detected, the method 600 may return to block 614 where the microphone signal is output to the headphones. When the optical pattern is no longer detected, such as after the emergency vehicle has passed the user, the method 600 may proceed to block 618. At block 618, the anti-noise signal and the audio signal are re-enabled and a sum of the audio signal and the anti-noise signal is output to the headphones. In one embodiment shown in FIG. 5, block 618 may involve activating the switches 512 and 514 and deactivating the switch 516. After the anti-noise signal and the audio signal are re-enabled, the method 600 may return to block 610 to playback the audio signal until an optical pattern is detected again at block 612.

If implemented in firmware and/or software, the functions described above, such as with reference to FIG. 4 and FIG. 6, may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), Electrically Erasable Programmable Read-Only Memory (EEPROM), compact disc-read only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. For example, although a strobe signal is described as one type of optical signal for detecting the presence of a vehicle, an audio controller may be configured to discriminate other types of optical signals. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An apparatus, comprising:
an optical sensor; and
an audio controller coupled to the optical sensor, wherein the audio controller is configured to:
output an audio signal to an audio transducing device;
detect an optical pattern corresponding to a presence of a vehicle in a signal received from the optical sensor; and
adjust the output audio signal based, at least in part, on the detection of the optical pattern corresponding to the presence of the vehicle.

2. The apparatus of claim 1, wherein the audio controller is configured to adjust the output audio signal by at least one of:
muting the output audio signal after the optical pattern is detected;
turning off a noise cancellation signal within the audio signal after the optical pattern is detected; and
adding to the output audio signal an audio signal corresponding to an audio signal representative of an environment around the audio transducing device after the optical pattern is detected.

3. The apparatus of claim 1, wherein the optical sensor comprises at least one of a visible light sensor and an infrared (IR) sensor.

4. The apparatus of claim 1, wherein the apparatus further comprises a microphone coupled to the audio controller, wherein the microphone receives an audio signal from the environment around the audio transducing device.

5. The apparatus of claim 4, wherein the audio controller is further configured to:
generate an anti-noise signal for canceling sounds in the environment around the audio transducing device based, at least in part, on the microphone audio signal;
add to the output audio signal the anti-noise signal; and
adjust the output audio signal by disabling the adding of the anti-noise signal to the output audio signal after the optical pattern is detected.

6. The apparatus of claim 1, wherein the audio controller is configured to disable the detection of the optical pattern.

7. The apparatus of claim 1, wherein the detected optical signal corresponds to a strobe of a traffic control preemption signal of an emergency vehicle.

8. The apparatus of claim 1, wherein the optical sensor is attached to a cord-mounted module attached to the apparatus.

9. The apparatus of claim 1, wherein the optical sensor is attached to the audio transducing device.

10. A method, comprising:
receiving, at an audio controller, a first input corresponding to a signal received from an optical sensor;
receiving, at the audio controller, a second input corresponding to an audio signal for playback through an audio transducing device;
detecting, by the audio controller, a pattern indicating a presence of a vehicle in the first input; and
adjusting, by the audio controller, the audio signal for playback through the audio transducing device after the pattern is detected.

11. The method of claim 10, wherein the step of adjusting the audio signal comprises at least one of:
muting the output audio signal when the pattern is detected;
turning off a noise cancellation signal within the audio signal when the pattern is detected; and
adding to the output audio signal an audio signal corresponding to an audio signal representative of an environment around the audio transducing device when the pattern is detected.

12. The method of claim 10, further comprising:
receiving, at an audio controller, a third input corresponding to an audio signal received from a microphone in an environment around the audio transducing device;
generating, by the audio controller, an anti-noise signal for canceling audio in the environment around the audio transducing device;
adding the anti-noise signal to the audio signal for playback through the audio transducing device; and
disabling the adding of the anti-noise signal to the output audio signal after the vehicle strobe pattern is detected.

13. The method of claim 10, further comprising disabling the detection of the vehicle.

14. The method of claim 10, wherein the pattern corresponds to a vehicle strobe of a traffic control preemption signal of an emergency vehicle.

15. An apparatus, comprising:
an optical sensor;
an audio input node configured to receive an audio signal;
an audio transducing device coupled to the audio input node; and
a pattern discriminator coupled to the optical sensor and coupled to the audio transducing device, wherein the pattern discriminator is configured to:
detect a pattern indicating a presence of a vehicle at the optical sensor; and
mute the audio transducing device when the pattern is detected.

16. The apparatus of claim 15, wherein the detected pattern comprises a strobe of a traffic control preemption signal of an emergency vehicle.

17. The apparatus of claim 15, wherein the optical sensor comprises at least one of a visible light sensor and an infrared (IR) sensor.

18. The apparatus of claim 15, wherein the optical sensor, the audio transducing device, and the pattern discriminator are integrated into headphones.

19. The apparatus of claim 15, further comprising a controller configured to adjust an output audio signal of the audio transducing device based, at least in part, on the pattern detection.

20. The apparatus of claim 19, wherein the audio controller is configured to adjust the output audio signal by at least one of:
turning off a noise cancellation signal within the audio signal after the pattern is detected; and
adding to the output audio signal an audio signal corresponding to an audio signal representative of an environment around the audio transducing device after the pattern is detected.
